(19) United States
(12) Patent Application Publication
(10) Pub. No.: US 2025/0204308 A1
(43) Pub. Date: Jun. 26, 2025

(54) AUTONOMOUS LAWNMOWER

(71) Applicant: HONDA MOTOR CO., LTD., Tokyo (JP)

(72) Inventors: Kenji NISHIMIYA, Saitama (JP); Nikunj SHAH, Saitama (JP)

(21) Appl. No.: 18/848,916

(22) PCT Filed: Mar. 23, 2022
(86) PCT No.: PCT/JP2022/013567

§ 371 Date: Sep. 20, 2024

(51) Int. Cl. A01D 34/00; A01D 101/00; G05D 1/648; G05D 105/15

(52) U.S. Cl. CPC A01D 34/008; G05D 1/6484; A01D 2101/00; G05D 2105/15

(57) ABSTRACT

An autonomous lawn mower comprises: a lawnmower body that performs predetermined lawn mowing work while autonomously traveling on vegetation; a rearward imaging means provided, directed toward the rear in the running direction of the lawnmower body; a storage unit that stores the content of the predetermined lawn mowing work performed by the lawnmower body; and a control unit that controls the drive of the lawnmower body and, according to an imaging result of the rearward imaging means, instructs rework on the vegetation at an imaging location indicated by the imaging result.

### TECHNICAL FIELD

The present invention relates to an autonomous lawnmower.

### BACKGROUND ART

In recent years, self-propelled lawnmowers have been in demand to improve work efficiency. For instance, Patent Document 1 discloses a lawnmower as a self-propelled working robot. This lawnmower includes sensors for detecting obstacles ahead in the traveling direction. When the sensors detect obstacles during the lawn mowing, the lawnmower memorizes the locations of the obstacles and mows the lawn as planned while avoiding the obstacles. After completing the lawn mowing, the lawnmower moves to the memorized locations to check if the obstacles have been removed. If the obstacles have been removed, the lawnmower mows the remaining lawn on the locations.

### CITATION LIST

### Patent Document

Patent Document 1: Japanese Unexamined Patent Application, Publication No. H3-73004

### DISCLOSURE OF THE INVENTION

### Problems to be Solved by the Invention

The finishing quality of lawn mowing by self-propelled lawnmowers may not necessarily be stable at a high level due to various factors, as compared to lawn mowing by specialized workers. If insufficient spots remain as a result of lawn mowing by conventional self-propelled lawnmowers, such spots could not be identified, potentially leading to unevenness in the condition of mown grass.

Under such circumstances, the present invention aims to provide an autonomous lawnmower capable of mowing the lawn stably at a high level of finishing quality.

### Means for Solving the Problems

(1) An autonomous lawnmower (e.g., autonomous lawnmower 1 described later) according to the present invention includes: a lawnmower body (e.g., lawnmower body 2 described later) that performs predetermined lawn mowing while autonomously traveling on vegetation; a backward imager (e.g., backward imaging device 4 described later) oriented backward in the traveling direction of the lawnmower body; a storage (e.g., storage unit 6 described later) that stores content of the predetermined lawn mowing by the lawnmower body; and a control unit (e.g., control unit 5 described later) that controls drive of the lawnmower body and instructs rework on the vegetation at the imaged location depending on the imaging result of the backward imager.
(2) In the autonomous lawnmower described in (1) above, the storage may store the imaged location during the predetermined lawn mowing, the imaged location being located backward of the lawnmower body in the traveling direction, and the control unit may change the operational content of the predetermined lawn mowing to the operational content of the lawn mowing on the vegetation at the imaged location during the rework.
(3) In the autonomous lawnmower described in (2) above, the control unit may set the traveling speed of the lawnmower body during the rework higher than the traveling speed of the lawnmower body during the predetermined lawn mowing.
(4) In the autonomous lawnmower described in (3) above, the control unit may set the rotation speed of the blade part (e.g., cutter blade 241 described later) of the lawnmower body during the rework higher than the rotation speed of the blade part of the lawnmower body during the predetermined lawn mowing.
(5) In the autonomous lawnmower described in any one of (2) to (4) above, the control unit may change a traveling direction of the lawnmower body during the predetermined lawn mowing operation to a traveling direction of the lawnmower body during the rework.
(6) In the autonomous lawnmower described in any one of (2) to (4) above, the control unit may issue an abnormal notification based on the imaging result and, when the abnormal notification persists for a predetermined interval or longer in the traveling direction of the lawnmower body during the predetermined lawn mowing, the control unit may cause the lawnmower body to move, during the rework, in the same direction as the traveling direction of the lawnmower body in the predetermined lawn mowing.
(7) In any one of the autonomous lawnmowers described in (2) to (6) above, when there are a plurality of rework spots for which the rework is instructed, the control unit may determine a sequence of operations on the plurality of rework spots, based on the imaged locations or the imaging results.
(8) In the autonomous lawnmower described in (7) above, the control unit may determine the sequence of operations on the plurality of rework spots, based on comparison of the imaging results of the plurality of rework spots.
(9) In the autonomous lawnmower described in any one of (1) to (8) above, the control unit may notify a predetermined external terminal when detecting that an amount of grass (e.g., amount of clumps of grass clippings Gc1 described later) discharged from the lawnmower body exceeds a threshold, based on the imaging result.

### Effects of the Invention

According to (1), the autonomous lawnmower instructs rework on the vegetation at the imaged location, based on the imaging result of the backward imager, allowing for mowing the lawn stably at a high level of finishing quality.

According to (2), the autonomous lawnmower mows the lawn under different operating conditions at the rework spots where the results of the normal operation were insufficient, whereby allowing for further improving the finishing quality of rework.

According to (3), since the grass density in the rework spots is already reduced by the normal lawn-mowing operation, the traveling speed of the autonomous lawnmower can be increased during rework to improve operational efficiency without compromising the finishing quality.

According to (4), an increase in the rotation speed of the blade part results in more frequent contact of the blade part with the grass per unit area, mitigating the risk of leaving unmown grass even when the autonomous lawnmower travels at higher speeds. As a result, operational efficiency can be further enhanced.

According to (5), the traveling direction of the autonomous lawnmower during normal operation is changed to the traveling direction during rework, whereby reducing the risk of leaving unmown grass, further improving the finishing quality of rework.

According to (6), even in cases where a lengthy unmown region remains due to the error in the lap width, the autonomous lawnmower can efficiently process such a region through rework.

According to (7), the autonomous lawnmower can efficiently perform rework according to the sequence of operations, reducing unnecessary power consumption.

According to (8), the autonomous lawnmower can perform efficient rework tailored to the condition of the grass at the rework spots.

According to (9), abnormal conditions that cannot be processed by the autonomous lawnmower can be reported to operation managers or the like, allowing for improving the convenience of the autonomous lawnmower, further enhancing the finishing quality of mowing the lawn.

### BRIEF DESCRIPTION OF THE DRAWINGS

FIG. 1 is a schematic side view illustrating an autonomous lawnmower;

FIG. 2A is a diagram illustrating the proper mowing of grass;

FIG. 2B is a diagram illustrating the condition of properly mown grass;

FIG. 3A is a diagram illustrating the improper mowing of grass;

FIG. 3B is a diagram illustrating the grass with white tips as a result of improper mowing;

FIG. 4 is a plan view illustrating grass dropped during the lawn mowing;

FIG. 5 is a functional block diagram of a control unit;

FIG. 6 is a functional block diagram of an operational content determination unit;

FIG. 7 is a diagram illustrating an example of a reward table;

FIG. 8 is a diagram illustrating an example of a setting value adjustment table;

FIG. 9 is a diagram illustrating an example of an operational path from the start to end of the operation by the autonomous lawnmower;

FIG. 10 is a flowchart illustrating an example of control operation for the autonomous lawnmower in determining operational content;

FIG. 11 is a flowchart illustrating an example of control operation for the autonomous lawnmower in determining rework;

FIG. 12A is a flowchart illustrating an example of control operation of rework by the autonomous lawnmower;

FIG. 12B is a flowchart illustrating an example of control operation of rework by the autonomous lawnmower;

FIG. 13 illustrates rework by the autonomous lawnmower in the working area;

FIG. 14 illustrates an example of the traveling direction during rework by the autonomous lawnmower; and

FIG. 15A is a diagram illustrating the concept of overlap; and

FIG. 15B is a diagram illustrating the traveling directions during rework by the autonomous lawnmower on the error in the lap width.

### PREFERRED MODE FOR CARRYING OUT THE INVENTION

### Outline Configuration of Autonomous Lawnmower

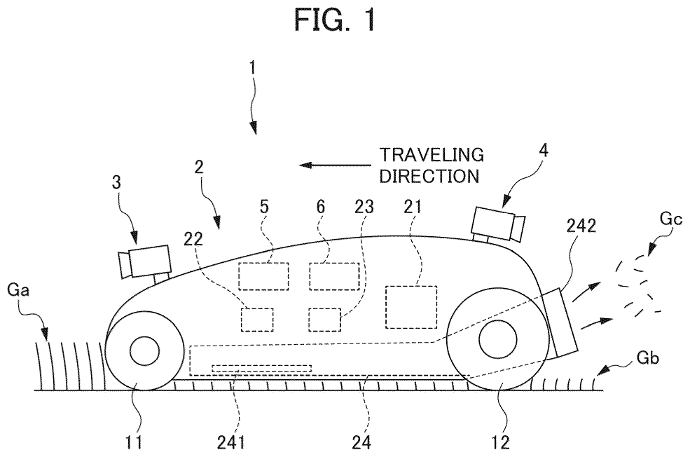

As illustrated in FIG. 1, an autonomous lawnmower 1 includes a lawnmower body 2, a forward imaging device 3, a backward imaging device 4, a control unit 5, and a storage unit 6. The autonomous lawnmower 1 includes a pair of front wheels 11 and a pair of rear wheels 12, and autonomously travels while mowing the lawn on the vegetation within a working area, driven by a traveling motor 21 integrated into the lawnmower body 2. In addition to the above, the autonomous lawnmower 1 includes a steering mechanism for changing the traveling direction, rechargeable drive batteries, etc., which are not illustrated in FIG. 1.

Describing the autonomous lawnmower 1 of the present embodiment, the left direction indicated by the arrow in FIG. 1 represents the traveling direction during the lawn mowing. Therefore, in the autonomous lawnmower 1 of the present embodiment illustrated in FIG. 1, forward in the traveling direction is toward the left, and backward in the traveling direction is toward the right. The width direction of the autonomous lawnmower 1 of the present embodiment is a direction perpendicular to the surface of the paper in FIG. 1.

The lawnmower body 2 houses a cutter deck 24 at the bottom, which contains a lawn-mowing blade part. The specific structure of the blade part is not particularly limited. In the present embodiment, the blade part consists of a pair of cutter blades 241 arranged side by side in the width direction of the lawnmower body 2. The cutter blades 241 rotate at a predetermined speed around a rotation axis approximately perpendicular to the ground, driven by a blade motor 22 integrated into the lawnmower body 2, to mow the grass Ga ahead in the traveling direction. When the autonomous lawnmower 1 properly mows the lawn, the grass Gb after the passage of the autonomous lawnmower 1 is trimmed to a predetermined length.

The cutter deck 24 is vertically movable relative to the lawnmower body 2, driven by a deck elevation motor 23 integrated into the lawnmower body 2. The vertical movement of the cutter deck 24 adjusts the height of the cutter blades 241 relative to the ground, ensuring the proper length of the mown grass Gb.

The cutter deck 24 has a discharge opening 242 that opens in the back of the lawnmower body 2. The discharge opening 242 discharges and disperses the grass clippings Gc, mown by the cutter blades 241, backward in the traveling direction by way of the airflow generated by the rotation of the cutter blades 241. The adequately dispersed grass clippings Gc can be reused as soil fertilizer.

The forward imaging device 3 is oriented forward in the traveling direction of the lawnmower body 2. Specifically, the forward imaging device 3 is mounted, oriented slightly downward, on the upper front part of the lawnmower body 2 to enable imaging of the unmown grass Ga ahead in the traveling direction during the lawn mowing.

As a specific example of the forward imaging device 3, a camera including an image sensor capable of color image recognition of the grass Ga can be used. The forward imaging device 3 may be a moisture-sensing camera capable of measuring the moisture content of the grass Ga. For example, a near-infrared spectrometric moisture-sensing camera can be used as the moisture-sensing camera.

The forward imaging device 3 may include two or more types of cameras, such as a camera with image sensors, and a near-infrared spectrometric moisture-sensing camera. The forward imaging device 3 captures images of the unmown grass Ga ahead in the traveling direction, and sends the forward imaging result, including the condition of the grass Ga, to the control unit 5.

The backward imaging device 4 is oriented backward in the traveling direction of the lawnmower body 2. Specifically, the backward imaging device 4 is mounted, oriented slightly downward, on the upper rear part of the lawnmower body 2 to enable imaging of the grass Gb backward to the traveling direction during the lawn mowing.

As a specific example of the backward imaging device 4, a camera including an image sensor capable of color image recognition of the grass Gb can be used. The backward imaging device 4 captures images of the mown grass Gb backward to the traveling direction, and sends the backward imaging result, including the condition of the grass Gb, to the control unit 5.

The following describes the condition of the grass Ga included in the forward imaging result, and the condition of the grass Gb included in the backward imaging result.

The condition of the grass Ga included in the forward imaging result may include the number (density), thickness, color, moisture content, etc., of the grass Ga. These conditions of the grass Ga can be recognized by image processing of the forward imaging result.

The number and thickness of the grass Ga is relevant to the ease of mowing the grass Ga. For example, when the grass Ga is numerous or thick, the grass Ga may be difficult to cut. In such cases, adjustments such as reducing the traveling speed of the autonomous lawnmower 1 or increasing the rotation speed of the cutter blades 241 may be necessary. Therefore, information on the number and thickness of the grass Ga as the condition of the grass Ga can be used as the basis for determining the traveling speed of the autonomous lawnmower 1 and the rotation speed of the cutter blades 241 for more appropriate lawn mowing.

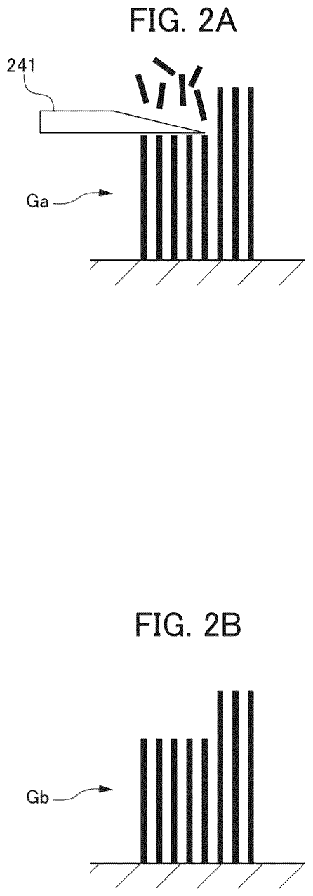

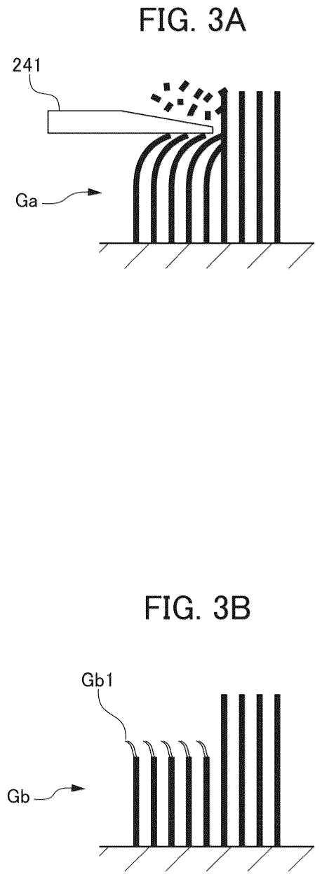

The color of the grass Ga is relevant to assessing the finishing state of the mown grass Gb. For instance, as illustrated in FIG. 2A, when the rotation speed of the cutter blades 241 is appropriate, the grass Ga is neatly mown by the cutter blades 241. Consequently, as illustrated in FIG. 2B, the mown grass Gb has been neatly trimmed to a predetermined length, resulting in minimal difference in color between the unmown grass Ga and the mown grass Gb. However, as illustrated in FIG. 3A, when the rotation speed of the cutter blades 241 is slow or the sharpness of the cutter blades 241 deteriorates due to wear, the cutter blades 241 may push down the grass Ga, making it difficult to neatly mow the grass Ga. As a result, as illustrated in FIG. 3B, fibers are exposed as white tips Gb1 remaining at the mown edge of the mown grass Gb. Consequently, the color of the grass Gb becomes generally whitish, significantly differing from the color of the grass Ga. Therefore, the color of the grass Ga can be used, for example, as a criterion for determining the appropriate rotation speed of the cutter blades 241.

The moisture content of the grass Ga refers to the amount of moisture adhering to the grass Ga. The moisture content of the grass Ga can be measured with a moisture-sensing camera. The moisture content of the grass Ga can also be measured by detecting light reflected from the grass Ga using a camera with an image sensor. The moisture content of the grass Ga may also involve external input information such as rainfall or irrigation. Moisture adhering to the grass Ga contributes to an increase in the mass of the grass Ga. For instance, with higher moisture content, the grass Ga is more prone to lodging. Consequently, the grass Ga is unlikely to stand up, and is thus prone to remain unmown. Therefore, the moisture content of the grass Ga can be used, for example, as a criterion for determining the appropriate rotation speed of the cutter blades 241 to generate updrafts that can help stand up the grass Ga lodged by moisture.

The condition of the grass Gb included in the backward imaging result is the finishing state of the mown grass Gb. The finishing state of the grass Gb may include the appearance of grass remaining unmown, the color of the grass Gb, the amount of dropped grass, and the length of the grass Gb (mowing height, unevenness in length), among others. These finishing states of the grass Gb can be recognized by image processing of the backward imaging result.

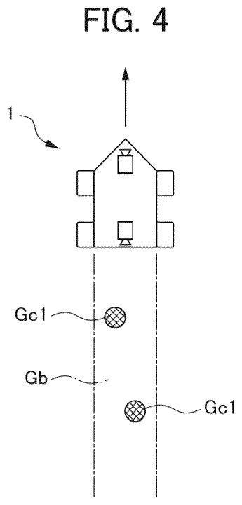

Dropped grass refers to the grass clippings Gc accumulated as clumps on the grass Gb without being dispersed when discharged backward in the traveling direction of the autonomous lawnmower 1. As a result, as illustrated in FIG. 4, the grass clippings Gc accumulated as the clumps Gc1 are scattered on the grass Gb backward in the traveling direction of the autonomous lawnmower 1. Since sunlight and moisture are less likely to reach the grass Gb under the clumps of grass clippings Gc1, such grass Gb may die. Therefore, a large amount of grass forming the clumps of grass clippings Gc1 needs to be immediately removed.

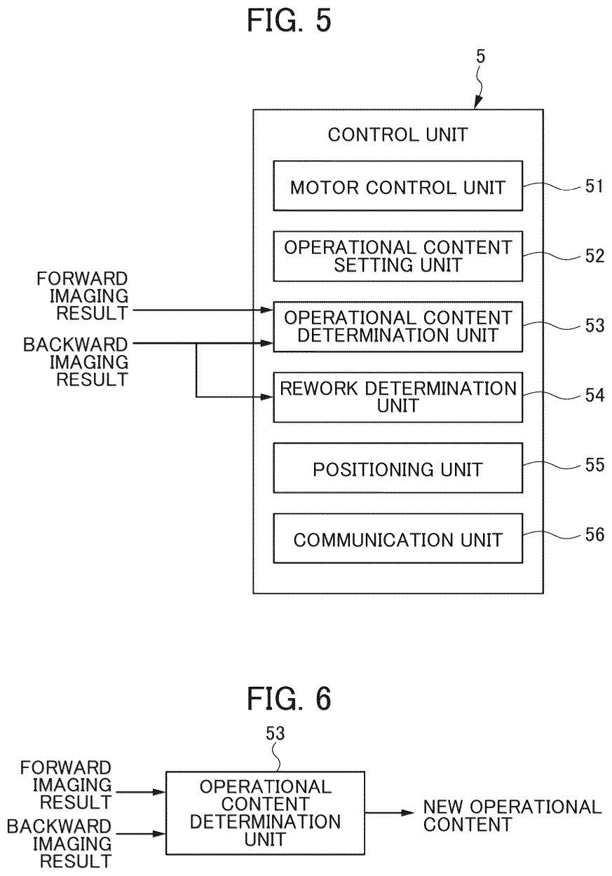

The control unit 5 comprehensively controls the operation of the autonomous lawnmower 1. As illustrated in FIG. 5, the control unit 5 includes a motor control unit 51, an operational content setting unit 52, an operational content determination unit 53, a rework determination unit 54, a positioning unit 55, and a communication unit 56.

The motor control unit 51 generates operation commands for various motors, based on the set values of the operational content set in the operational content setting unit 52. The motor control unit 51 sends the generated operation commands to various motors such as the traveling motor 21, the blade motor 22, and the deck elevation motor 23, whereby controlling the drive of the various motors. This realizes the lawn mowing of the autonomous lawnmower 1.

The operational content setting unit 52 sets the operational content required for the lawn mowing of the autonomous lawnmower 1. The operational content includes parameters for operating the various parts of the autonomous lawnmower 1. The operational content includes information on the traveling direction and the traveling speed of the autonomous lawnmower 1, the rotation speed of the cutter blades 241, and the height of the cutter deck 24. The operational content set in the operational content setting unit 52 is rewritable, and adjusted based on the information sent from the operational content determination unit 53.

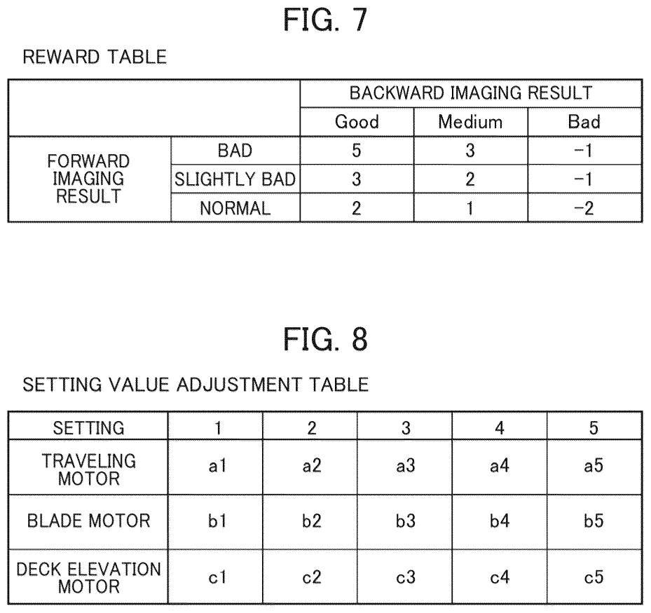

As illustrated in FIG. 6, the operational content determination unit 53 determines and outputs new operational content to achieve better results of lawn mowing, based on both the forward imaging result detected by the forward imaging device 3 and the backward imaging result detected by the backward imaging device 4. The operational content determination unit 53 identifies the condition of the grass Gb included in the backward imaging result detected by the backward imaging device 4 and, if the condition of the grass Gb is within a predetermined range, determines new operational content, based on the condition of the grass Ga included in the forward imaging result detected by the forward imaging device 3.

The operational content determination unit 53 can determine new operational content, for example, through reinforcement learning. Reinforcement learning involves learning the lawn mowing (action) performed by the autonomous lawnmower 1 to maximize future rewards. Specifically, the operational content determination unit 53 performs lawn mowing (action) based on certain operational content, and chooses an action that improves the condition of the unmown grass Ga included in the forward imaging result to a better condition of the mown grass Gb detected in the backward imaging result.

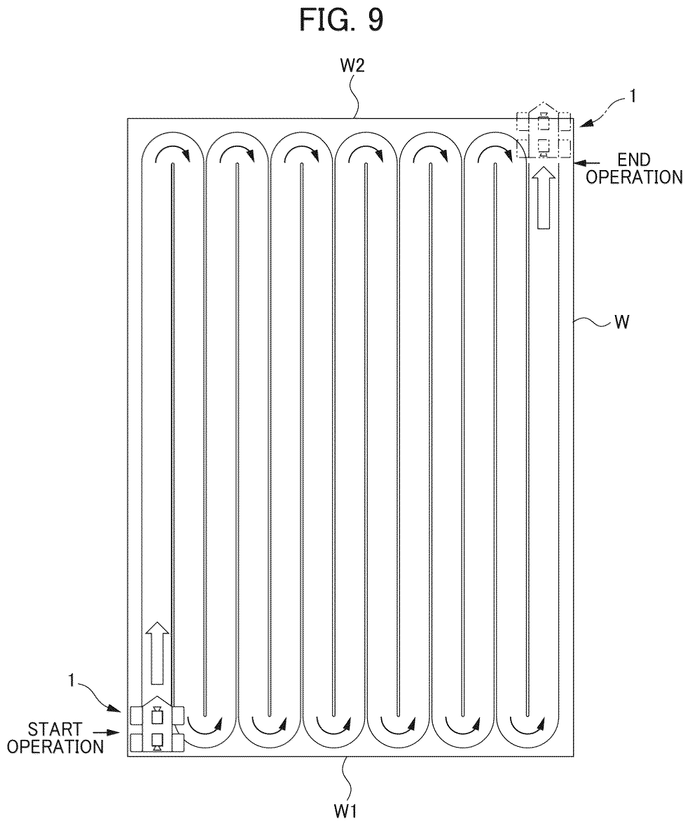

In reinforcement learning by the operational content determination unit 53, as a result of the lawn mowing based on the operational content set in the operational content setting unit 52, a positive value is assigned to the reward when the condition of the mown grass Gb is better than the condition of the unmown grass Ga, and a negative value is assigned to the reward when the condition of the mown grass Gb is worse than the condition of the unmown grass Ga. Specifically, a reward table as illustrated in FIG. 7, for example, is preset in the operational content determination unit 53. Based on the reward table, the operational content determination unit 53 evaluates, for example, the condition of the unmown grass Ga in the forward imaging result as “normal”, “slightly bad”, or “bad” on a three-level scale, and evaluates the condition of the mown grass Gb in the backward imaging result as “good”, “medium”, or “bad” on a three-level scale. The operational content determination unit 53 calculates either a positive or negative reward value, based on the combinations of the above.

As illustrated in FIG. 7, the reward values are weighted. For instance, the case in which the condition of the grass Ga in the forward imaging result is “bad” and the condition of the grass Gb in the backward imaging result is “good” indicates that the operational content of the lawn mowing is extremely excellent. Therefore, in this combination, the reward value is weighted to be larger than in other combinations. Conversely, the case in which the condition of the grass Ga in the forward imaging result is “normal” and the condition of the grass Gb in the backward imaging result is “bad” indicates that the operational content of the lawn mowing is poor. Hence, in this combination, the reward value is weighted to be smaller than in other combinations.

This method of calculating rewards is an example and not limited thereto. Another example of a method of calculating rewards may involve quantifying the forward images and backward images and calculating (e.g., adding) these numerical values, whereby calculating the reward values. For instance, the condition of the grass Ga included in the forward imaging result may be quantified as “normal: 0 points”, “slightly bad: 3 points”, or “bad: 5 points”, and the condition of the mown grass Gb included in the backward imaging result may be quantified as “good: 5 points”, “medium: 3 points”, or “bad: −1 point”. The reward is calculated by adding the numerical values of the forward and backward images. Thus, for example, even if the condition of the grass Ga included in the forward imaging result is “bad: 5 points”, if the condition of the mown grass Gb included in the backward imaging result is “good: 5 points”, the total is 10 points, yielding the highest reward. Conversely, even if the condition of the grass Ga included in the forward imaging result is “normal: 0 points”, and the condition of the mown grass Gb included in the backward imaging result is “bad: −1 point”, the total is −1 point, resulting in the lowest reward.

Based on the condition of the unmown grass Ga included in the forward imaging result, the operational content of the lawn mowing on the grass Ga, the condition of the mown grass Gb included in the backward imaging result, and the reward values calculated therefrom, the operational content determination unit 53 determines new operational content as a new action for the current condition, for example, through deep learning. The operational content determination unit 53 links together the condition of the grass Ga, the condition of the grass Gb, the operational content of mowing such grass, and the rewards, and accumulates them as an experience to determine new operational content.

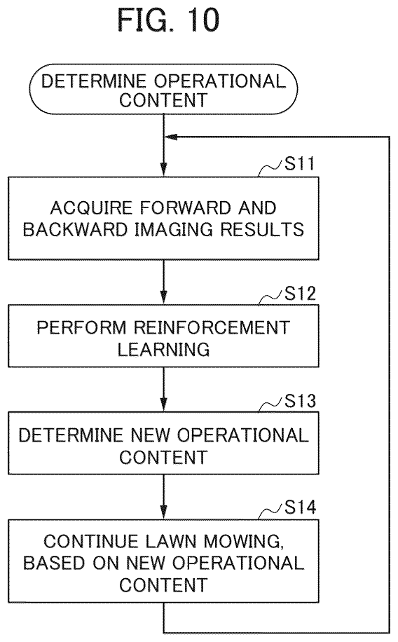

The operational content newly determined by the operational content determination unit 53 through reinforcement learning includes adjustments such as increasing or decreasing the rotation speed of the cutter blades 241, raising or lowering the height of the cutter deck 24, or accelerating or decelerating the traveling speed of the autonomous lawnmower 1, aiming to obtain a higher positive reward as compared to the current operational content. Specifically, the operational content determination unit 53 is pre-set with a setting value adjustment table, as illustrated in FIG. 8, for instance. For example, when the current operational content of the blade motor 22 is set at, for instance, “3” (b3), the operational content determination unit 53 adjusts the new operational content to, for instance, “2” (b2) or “4” (b4). The new operational content is sent to the operational content setting unit 52, in which the operational content of the lawn mowing recorded in the operational content setting unit 52 is updated to operational content that enables more appropriate lawn mowing.

The operational content determination unit 53 determines the operational content, and the operational content setting unit 52 makes adjustment, during a predetermined control cycle after the autonomous lawnmower 1 started lawn mowing. Based on the operational content of the lawn mowing newly rewritten in the operational content setting unit 52, the control unit 5 causes the motor control unit 51 to update the operation commands for each motor, and continues the lawn mowing of the autonomous lawnmower 1.

The rework determination unit 54 determines whether rework of the lawn mowing is necessary, based on the finishing state after the lawn mowing included in the backward imaging result of the backward imaging device 4. Specifically, the rework determination unit 54 determines whether rework is necessary, based on the conditions of the mown grass Gb after the lawn mowing, such as the appearance of grass remaining unmown, the appearance of dropped grass, and the color of the grass Gb. In the case of determining that rework is necessary, the rework determination unit 54 issues an abnormal notification. The abnormal notifications may not necessarily be limited to explicit notifications to external terminals but may include information indicating the determination that rework is necessary.

When the rework determination unit 54 determines that rework is necessary, the control unit 5 issues instructions for the rework. The rework instructions include a notification to the operation manager, and a rework instruction for the autonomous lawnmower 1.

Rework is not limited to the operation performed by the autonomous lawnmower 1. Rework may also involve notifications of rework content to external terminals such as mobile devices or personal computers owned by operation managers via the communication unit 56. This enables, for example, prompting the operation manager to perform operations which cannot be done by the autonomous lawnmower 1, such as removing the clumps of grass clippings Gc1.

The positioning unit 55 measures the current position and the traveling direction of the autonomous lawnmower 1 that is currently mowing the lawn. Specifically, any positioning unit 55 capable of measuring the current position of the autonomous lawnmower 1 during the lawn mowing may be used without limitation. For example, the positioning unit 55 can measure the current position of the autonomous lawnmower 1 using GPS (Global Positioning System). The positioning unit 55 may use lasers or similar means to measure the distance and angle to specific locations, such as the charging point of the autonomous lawnmower 1, whereby determining the current position of the autonomous lawnmower 1.

The communication unit 56 carries out wireless communication between the autonomous lawnmower 1 and external devices such as external terminals.

Returning to FIG. 1, the storage unit 6 stores various data on the operation of the autonomous lawnmower 1 during the lawn mowing. Specifically, the storage unit 6 stores the operational content during the lawn mowing of the autonomous lawnmower 1. The operational content includes information such as the forward imaging result captured by the forward imaging device 3, the backward imaging result captured by the backward imaging device 4, information on the position and imaged location of the autonomous lawnmower 1 measured by the positioning unit 55, and the operational content of the autonomous lawnmower 1.

The control unit 5, including the various functional blocks described above, is composed of a processing unit such as a CPU (Central Processing Unit). In order to implement the functions of each functional block, the control unit 5 may include auxiliary storage devices such as HDD (Hard Disk Drive) containing various control programs such as application software and OS (Operating System), as well as main memory devices such as RAM (Random Access Memory) for temporarily storing data required by the processing unit during program execution. The storage unit 6, for instance, can be composed of storage devices such as RAM (Random Access Memory).

The control unit 5 is not limited to being integrated within the lawnmower body 2. All or part of the functions of the control unit 5 may be provided, for example, in external terminals such as personal computers, and connected via network lines, allowing communication through network connections.

### Determination of Operational Content of Autonomous Lawnmower

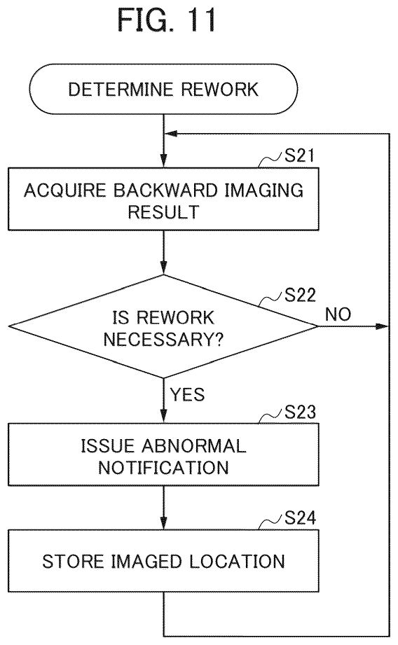

Next, the control when determining specific operational content of the autonomous lawnmower 1 in the present embodiment will be described. First, using FIG. 9, the movement path of the autonomous lawnmower 1 of the present embodiment during the lawn mowing will be described. Here, FIG. 9 illustrates a plan view of a rectangular working area W. The autonomous lawnmower 1 before the lawn mowing is stationed at the operation starting position in the lower-left corner of the working area W.

During the lawn mowing, the autonomous lawnmower 1 in the present embodiment moves linearly from the lower edge W1 to the upper edge W2 of the working area W, then changes the direction by 180 degrees at the upper edge W2 and moves linearly towards the lower edge W1. Upon reaching the lower edge W1, the autonomous lawnmower 1 changes the direction by 180 degrees again and moves linearly towards the upper edge W2. The autonomous lawnmower 1 repeats this movement between the edges W1 and W2 from the operation starting position to the operation ending position, mowing the lawn across the entire working area W. Information on such movement paths of the autonomous lawnmower 1 is pre-stored, for example, in the storage unit 6.

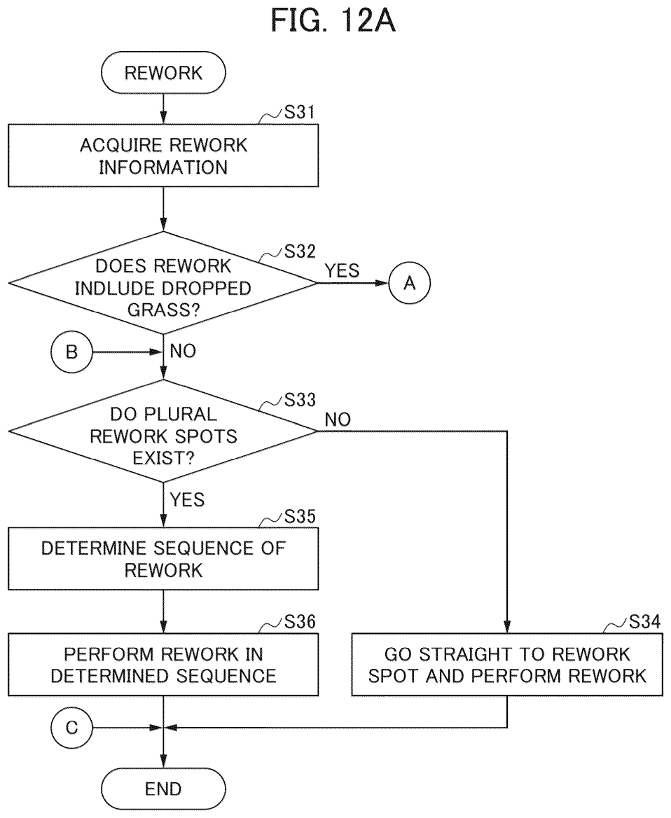

FIG. 10 is a flowchart illustrating the control operation for determining operational content of the autonomous lawnmower 1. The control unit 5 drives the traveling motor 21, the blade motor 22, and the deck elevation motor 23, based on the operational content recorded in the operational content setting unit 52. As a result, the autonomous lawnmower 1 mows the lawn while moving along the movement path as illustrated in FIG. 9.

When the lawn mowing starts, the control unit 5 acquires the forward imaging result of the forward imaging device 3 and the backward imaging result of the backward imaging device 4 (Step S11). As a result, the condition of the unmown grass Ga and the condition of the mown grass Gb are acquired. The control unit 5 executes reinforcement learning, based on the conditions of the grass Ga and Gb (Step S12).

Through the reinforcement learning by the operational content determination unit 53, the control unit 5 calculates rewards based on the condition of the grass Ga detected from the forward imaging result and the condition of the grass Gb detected from the backward imaging result, and determines new operational content of the lawn mowing which is better than the current operational content, based on the rewards (Step S13).

The information on the condition of the unmown grass Ga included in the forward imaging result preferably includes at least information on the moisture content of the grass Ga. This allows the control unit 5 to determine operational content taking into account the moisture content of the grass Ga.

When the condition of the grass Ga included in the forward imaging result includes information on at least the number of the grass Ga and/or the thickness of the grass Ga, and information on the moisture content of the grass Ga, the control unit 5 preferably prioritizes the moisture content of the grass Ga over the number and thickness of the grass Ga when determining new operational content. For example, even if the condition of the grass Ga is judged as “normal” as illustrated in FIG. 7 due to a low number of the grass Ga or thinness of the grass Ga, when the moisture content of the grass Ga is high, the grass Ga may lodge under the weight of moisture, and be prone to remain unmown. In such cases, the condition of the grass Ga is judged as “bad”. As a result, the control unit 5 can determine more appropriate operational content, based on the moisture content of the unmown grass Ga included in the forward imaging result.

When the condition of the grass Ga included in the forward imaging result includes information on both the number and thickness of the grass Ga, the control unit 5 preferably prioritizes the thickness of the grass Ga over the number of the grass Ga when determining new operational content. When each individual grass Ga is thick, mowing is more challenging as compared to mowing a plurality of thinner grasses, and requires more torque for mowing. For instance, even if the condition of the grass Ga is judged as “normal” as illustrated in FIG. 7 due to the presence of a plurality of thin grasses, when thick grasses are also present, the condition of the grass Ga is judged as “slightly bad”. As a result, the control unit 5 can determine more appropriate operational content, based on the thickness of the grass Ga.

When the condition of the grass Gb included in the backward imaging result includes information on both the amount of clumps of grass clippings Gc1 and the condition of the grass Gb (e.g., grass remaining unmown, color of grass), the control unit 5 preferably prioritizes the amount of clumps of grass clippings Gc1 over the condition of the grass Gb when determining new operational content. The clumps of grass clippings Gc1 may cause the grass dying. For example, even if the condition of the grass Gb is judged as “good” as illustrated in FIG. 7 due to the absence of unmown grass Gb or white tips Gb1, when the amount of clumps of grass clippings Gc1 is high, the condition of the grass Gb is judged as “bad”. As a result, the control unit 5 can determine more appropriate operational content, based on the amount of clumps of grass clippings Gc1.

When the condition of the grass Gb included in the backward imaging result includes information on both the color of the grass Gb and the length unevenness of the grass Gb, the control unit 5 preferably prioritizes the information on the change from the color of the grass Ga included in the forward imaging result to the color of the grass Gb included in the backward imaging result, over the information on the length unevenness of the grass Gb when determining new operational content. For example, even if the grass Gb is judged as “good” as illustrated in FIG. 7 due to the absence of unevenness in length, when the color of the grass Gb with the white tips Gb1 is whiter than the grass Ga, the condition of the grass Gb is judged as “bad”. As a result, the control unit 5 can determine more appropriate operational content, based on the appearance of white tips Gb1 of the grass Gb.

One possible factor contributing to the presence of white tips Gb1 in the grass Gb may be the decreased sharpness of the deteriorated cutter blades 241. Therefore, when the condition of the mown grass Gb is judged as “bad” due to the presence of white tips Gb1, the control unit 5 may notify the external terminal of the operation manager via the communication unit 56 and prompt replacement of the cutter blades 241.

When the new operational content is determined, the control unit 5 overwrites the operational content recorded in the operational content setting unit 52 with the new operational content, and causes the autonomous lawnmower 1 to operate based on the new operational content and continue mowing the lawn until reaching the operation ending position (Step S14).

### Rework by Autonomous Lawnmower

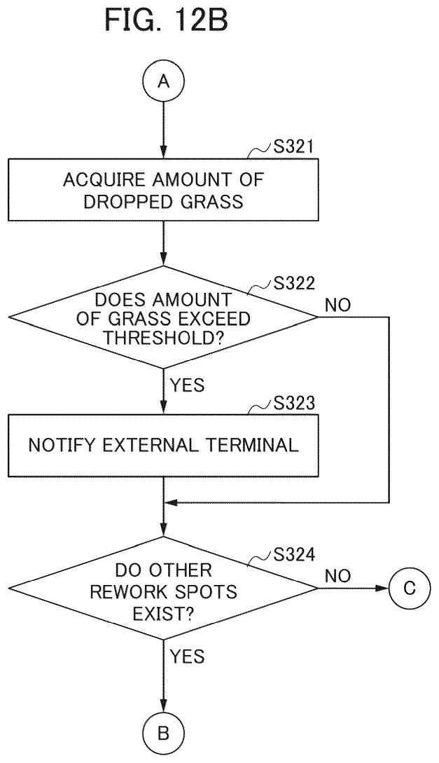

Next, the specific process for determining the necessity of rework by the autonomous lawnmower 1 in the present embodiment will be described using the flowchart of FIG. 11. Here again, the autonomous lawnmower 1 is described as mowing the lawn along the movement path in the working area W similar to that in FIG. 9.

The autonomous lawnmower 1 performs the predetermined lawn mowing on the vegetation within the working area W, based on the operational content set in the operational content setting unit 52. While the autonomous lawnmower 1 is mowing the lawn, the control unit 5 determines whether rework is necessary, based on the backward imaging result detected by the backward imaging device 4. That is, when the lawn mowing starts, the control unit 5 acquires the backward imaging result detected by the backward imaging device 4 at predetermined control intervals (Step S21).

The control unit 5 determines whether rework is necessary, based on the acquired backward imaging result (Step S22). Specifically, the control unit 5 causes the rework determination unit 54 to determine whether rework is necessary, based on the finishing state of the mown grass Gb included in the backward imaging result.

In the case of determining that rework is not necessary in Step S22 (Step S22; NO), the processing returns to Step S21.

In the case of determining that rework is necessary in Step S22 (Step S22; YES), the control unit 5 issues an abnormal notification indicating that rework is necessary (Step S23), and uses the abnormal notification as a trigger to store, in the storage unit 6, information such as the imaged location in the backward imaging result corresponding to the location for which determination of rework has been made (Step S24).

Specifically, the storage unit 6 stores the operational content of the lawn mowing when determining that rework is necessary. The operational content of the lawn mowing includes information such as the imaged location (position of the autonomous lawnmower 1 as measured by the positioning unit 55) included in the backward imaging result, information on the operational content during the lawn mowing, and information on the rework content (the appearance of grass remaining unmown, the appearance of dropped grass, etc.). The information on the imaged location is acquired from the position information measured by the positioning unit 55. Information on the traveling speed of the autonomous lawnmower 1 is acquired from the operation commands outputted to the traveling motor 21. Information on the rotation speed of the cutter blades 241 is acquired from the operation commands outputted to the blade motor 22. Information on the height of the cutter deck 24 is acquired from the operation commands outputted to the deck elevation motor 23. The storage unit 6 stores the information on the traveling speed of the autonomous lawnmower 1, the information on the rotation speed of the cutter blades 241, and the information on the height of the cutter deck 24, in association with the information on the imaged location.

The control unit 5 repeats the processing from Steps S21 through S24 until the autonomous lawnmower 1 reaches the operation ending position. When a plurality of rework spots exist during the lawn mowing, information on the operational content at each rework spot is stored in the storage unit 6.

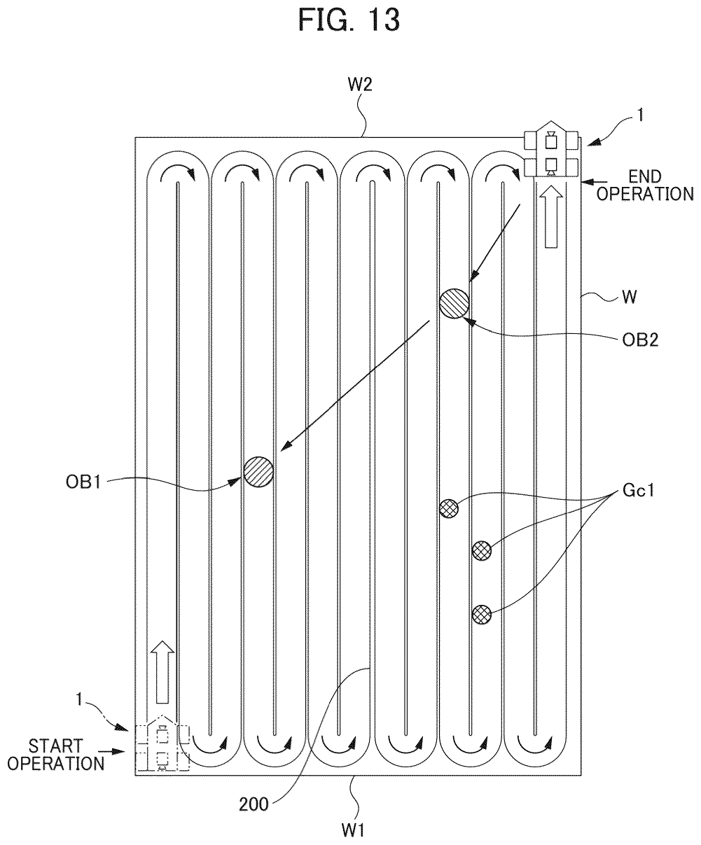

Rework is performed after the autonomous lawnmower 1 completes mowing the lawn on the vegetation within the working area W. The flow of rework operation is described using the flowcharts in FIGS. 12A and 12B. When the lawn mowing is over, the autonomous lawnmower 1 stops driving the cutter blades 241.

When the autonomous lawnmower 1 reaches the operation ending position and completes the lawn mowing, the control unit 5 acquires information on the operational content at all the rework spots stored in the storage unit 6 (Step S31).

Next, the control unit 5 reviews the operational content at each rework spot, and instructs rework on the vegetation at the imaged locations where rework is necessitated based on the backward imaging result. Specifically, at first, the control unit 5 determines whether dropped grass (clumps of grass clippings Gc1) exists, in view of the operational content (Step S32). A large amount of dropped grass may cause the grass to die, and thus the dropped grass needs to be immediately removed.

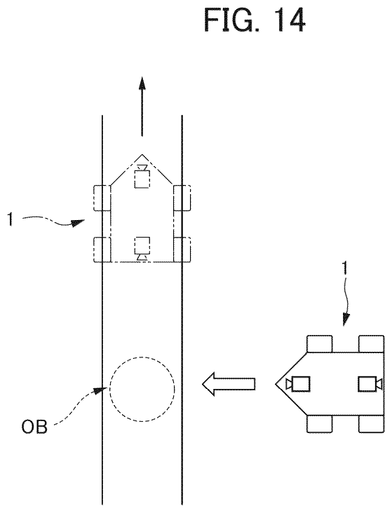

In Step S32, as illustrated in FIG. 13, if one or more spots of dropped grass (clumps of grass clippings Gc1) exist in the working area W after the lawn mowing (Step S32; YES), the control unit 5 acquires information on the amount of dropped grass on each spot (amount of clumps of grass clippings Gc1) from the operational content (Step S321).

Subsequently, the control unit 5 compares the acquired amount of grass with a pre-set threshold (Step S322). If the amount of grass exceeds the threshold (Step S322; YES), the control unit 5 provides a notification of this information to the external terminal of the operation manager via the communication unit 56 and instructs rework (Step S323). In other words, the control unit 5 notifies the operation manager that the amount of dropped grass exceeding the threshold exists at the specific locations of the working area W, and prompts removal of the clumps of grass clippings Gc1.

After notifying the operator, the control unit 5 further determines whether other rework spots exist besides the spots of dropped grass (Step S324). Even if the amount of grass does not exceed the threshold in Step S322 (Step S322; NO), the control unit 5 still determines whether other rework spots exist (Step S324). This is because a small amount of dropped grass is not judged as significant issues with the growth of the grass Gb and could instead be turned into soil fertilizer.

In the case of determining that no other rework spots exist in Step S324 (Step S324; NO), the rework determination processing ends.

In the case of determining that another rework spot exists in Step S324 (Step S324; YES), the control unit 5 checks whether a plurality of other rework spots exist (Step S33).

In the case of determining that only one other rework spot exists in Step S33 (Step S33; NO), the control unit 5 acquires the position information of this rework spot from the operational content and instructs the autonomous lawnmower 1 to perform rework (Step S34). In other words, the control unit 5 causes the autonomous lawnmower 1 to go straight to the rework spot and perform rework. As a result, the autonomous lawnmower 1 moves the shortest distance from the operation ending position to the rework spot.

On the other hand, in the case of determining that a plurality of other rework spots exist in Step S33 (Step S33; YES), the control unit 5 determines the sequence of rework for the plurality of rework spots, and instructs the autonomous lawnmower 1 to perform rework in the determined sequence (Step S35).

The sequence of rework can be determined in order of proximity to the rework spots. For example, as illustrated in FIG. 13, when two rework spots OB1 and OB2 exist in the working area W, the control unit 5 controls the autonomous lawnmower 1 to move the shortest distance to each rework spot in order of proximity to the autonomous lawnmower 1, performing rework at each rework spot in sequence, namely OB2 followed by OB1. This enables efficient rework and reduces unnecessary power consumption.

The sequence of rework can also be determined in order of necessity to rework. As an example of the order of necessity to rework, rework spots with larger areas of grass remaining unmown can be prioritized. This allows for minimizing the poor appearance of the grass Gb in the working area W while considering the remaining battery capacity.

Furthermore, the sequence of rework can be determined based on comparison of the condition of the grass Gb included in the backward imaging result of each rework spot. For example, rework is performed based on the order such as the darkness in color of the grass Gb, the number of the grass Gb remaining unmown, or the density of the grass Gb remaining unmown, whereby ensuring effective rework tailored to the condition of the grass Gb in each rework spot.

Once the sequence of rework is determined, the control unit 5 controls the autonomous lawnmower 1 to perform rework in the determined sequence. As a result, the autonomous lawnmower 1 performs rework at each rework spot (Step S36).

When the autonomous lawnmower 1 performs rework, it is preferable for the control unit 5 to change the work operation content during rework from the work operation content of the autonomous lawnmower 1 during normal operation (the first lawnmowing operation). Specifically, when performing rework, the control unit 5 changes at least one of the traveling direction and the traveling speed of the autonomous lawnmower 1, the rotation speed of the cutter blades 241, and the height of the cutter deck 24. The lawn can be mown under different operating conditions at rework spots where the normal operation yielded the insufficient outcome, whereby allowing for improving the operating efficiency, or further enhancing the finishing quality of rework.

More specifically, the control unit 5 increases the traveling speed of the autonomous lawnmower 1 for rework from the traveling speed of the autonomous lawnmower 1 for normal operation. Since the density of the grass Gb at rework spots is already lower as a result of the normal lawn-mowing operation, the control unit 5 can increase the traveling speed of the autonomous lawnmower 1 during rework to improve efficiency without compromising the finishing quality.

When the traveling speed of the autonomous lawnmower 1 is increased during rework, the control unit 5 preferably increases the rotation speed of the cutter blades 241 for rework from the rotation speed of the cutter blades 241 for normal operation. Increasing the rotation speed of the cutter blades 241 increases the frequency of the cutter blades 241 contacting the grass Gb per unit area, thus the grass Gb is unlikely to remain unmown even if the autonomous lawnmower 1 travels at higher speeds. Therefore, the efficiency can be further improved.

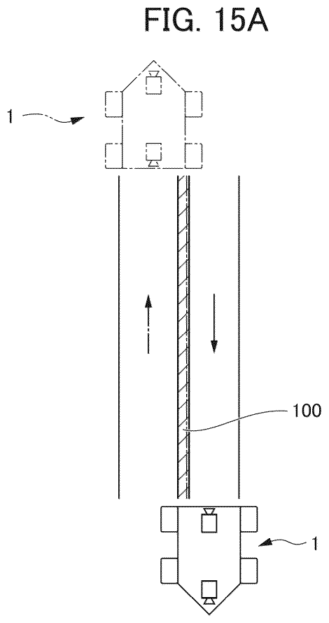

When the autonomous lawnmower 1 performs rework, the control unit 5 preferably changes the traveling direction of the autonomous lawnmower 1 for rework, from the traveling direction for normal operation. For example, as illustrated in FIG. 14, when the traveling direction for normal operation of the autonomous lawnmower 1 is from bottom to top, the autonomous lawnmower 1 performs rework at the rework spot OB while traveling in a direction different from the bottom to top. If the lawn is mown for rework in the same traveling direction as the normal operation, the conditions may be the same as the normal operation, leading to the risk of grass remaining unmown. By changing the traveling direction of the autonomous lawnmower 1 during rework from the traveling direction during normal operation, the quality of the finish during rework can be further improved.

FIG. 14 illustrates the case where the autonomous lawnmower 1 performs rework while traveling in a direction orthogonal to the traveling direction for normal operation. The traveling direction of the autonomous lawnmower 1 for rework is not limited to the direction orthogonal to the traveling direction for normal operation, but may be any direction intersecting the traveling direction for normal operation. The traveling direction of the autonomous lawnmower 1 for rework may be a direction opposite to the traveling direction for normal operation.

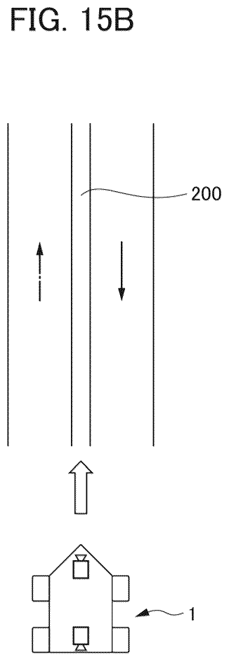

In Step S23 of the flowchart illustrated in FIG. 11, an abnormal notification triggered by determining that rework is necessary may persist over a predetermined time interval or a predetermined distance in the traveling direction of the autonomous lawnmower 1. Such abnormal notifications arise due to errors in the lap width during the lawn mowing. As illustrated in FIG. 15A, typically, the lawn is mown to create an overlap section 100 with a predetermined lap width between two adjacent rows of working areas (working ranges), in which the autonomous lawnmower 1 travels in directions being 180 degrees different. However, as illustrated in FIG. 15B, when the two adjacent rows of working areas (working ranges) do not overlap due to an error in the lap width, a lengthy unmown region 200 without overlap extends along the traveling direction of the autonomous lawnmower 1. In this case, the control unit 5 detects abnormalities over a predetermined time interval or predetermined distance in the traveling direction of the autonomous lawnmower 1, and thus continues to issue abnormal notifications.

When the control unit 5 detects abnormal notifications persisting over a predetermined time interval or distance in Step S23, the control unit 5 preferably causes the autonomous lawnmower 1 to perform rework while traveling along the traveling direction of the normal operation. This allows for efficiently processing the lengthy unmown region 200 arising from the error in the lap width. When an abnormal notification in Step S23 has ended within a predetermined time interval or distance, the control unit 5 changes the traveling direction of the autonomous lawnmower 1 during rework from the traveling direction during normal operation, as described above.

While the autonomous lawnmower 1 is moving towards the rework spots, the cutter blades 241 remain stationary. For example, when there is only one rework spot, the cutter blades 241 start operating when the autonomous lawnmower 1 reaches the rework spot to begin rework. When there are a plurality of rework spots, the cutter blades 241 start operating when the autonomous lawnmower 1 reaches each rework spot to begin rework. In other words, the cutter blades 241 remain stationary from ending rework at one rework spot until starting rework at the next rework spot. As a result, unnecessary power consumption can be reduced.

Once the rework at all rework spots is completed, the lawn mowing of the autonomous lawnmower 1 in the working area W is terminated.

In the above embodiments, the control unit 5 instructs rework on the dropped grass after the autonomous lawnmower 1 reaches the operation ending position and completes the lawn mowing, as in the case of instructing other rework; however, this is not limited thereto. The control unit 5 may issue rework instructions on dropped grass upon detecting the dropped grass.

In the above embodiments, the autonomous lawnmower 1 discharges the grass clippings Gc backward in the traveling direction; however, this is not limited thereto. The autonomous lawnmower may discharge the grass clippings Gc laterally to the traveling direction. In this case, the autonomous lawnmower may additionally include a lateral imaging device oriented laterally to the traveling direction to measure the amount of grass (the appearance of dropped grass) discharged laterally to the traveling direction.

### EXPLANATION OF REFERENCE NUMERALS

1: autonomous lawnmower
2: lawnmower body
241: cutter blade (blade part)
4: backward imaging device (backward imager)
5: control unit
6: storage unit
Gc1: clumps of grass clippings (grass discharged from the lawnmower body)

1. An autonomous lawnmower, comprising:
a lawnmower body that performs a predetermined lawn-mowing operation while autonomously traveling on vegetation;
a backward imager oriented backward in a traveling direction of the lawnmower body;
a storage that stores content of the predetermined lawn-mowing operation performed by the lawnmower body; and
a controller that controls drive of the lawnmower body and instructs rework on the vegetation at an imaged location depending on an imaging result of the backward imager.

2. The autonomous lawnmower according to claim 1, wherein
the storage stores the imaged location during the predetermined lawn-mowing operation, the imaged location being located backward of the lawnmower body in the traveling direction, and
the controller changes operational content of the predetermined lawn-mowing operation to operational content of lawn-mowing operation on the vegetation at the imaged location during the rework.

3. The autonomous lawnmower according to claim 2, wherein the controller increases a traveling speed of the lawnmower body for the rework from a traveling speed of the lawnmower body for the predetermined lawn-mowing operation.

4. The autonomous lawnmower according to claim 23, wherein the controller increases a rotation speed of a blade part of the lawnmower body for the rework from a rotation speed of the blade part of the lawnmower body for the predetermined lawn-mowing operation.

5. The autonomous lawnmower according to claim 2, wherein the controller changes a traveling direction of the lawnmower body during the predetermined lawn-mowing operation to a traveling direction of the lawnmower body during the rework.

6. The autonomous lawnmower according to claim 2, wherein the controller issues an abnormal notification based on the imaging result and, when the abnormal notification persists for a predetermined interval or longer in the traveling direction of the lawnmower body during the predetermined lawn-mowing operation, the controller causes the lawnmower body to move, during the rework, in the same direction as the traveling direction of the lawnmower body in the predetermined lawn-mowing operation.

7. The autonomous lawnmower according to claim 2, wherein, when there are a plurality of rework spots for which the rework is instructed, the controller determines a sequence of operations on the plurality of rework spots, based on the imaged location or the imaging result.

8. The autonomous lawnmower according to claim 7, wherein the controller determines the sequence of operations on the plurality of rework spots, based on comparison of the imaging result of each of the plurality of rework spots.

9. The autonomous lawnmower according to claim 1, wherein the controller notifies a predetermined external terminal when detecting that an amount of grass discharged from the lawnmower body exceeds a threshold, based on the imaging result.
